(19) United States
(12) Patent Application Publication
(10) Pub. No.: US 2026/0149155 A1
(43) Pub. Date: May 28, 2026

(54) PHASE SHIFTER ASSEMBLY, FEEDER PANEL, CAVITY PHASE SHIFTER, AND BASE STATION ANTENNA

(71) Applicant: Outdoor Wireless Networks LLC, Richardson, TX (US)

(72) Inventors: Fei Li, Suzhou (CN); Yan Wang, Suzhou (CN); Hangsheng Wen, Suzhou (CN); Jianpeng Lu, Suzhou (CN); Yuanpeng Ren, Suzhou (CN)

(21) Appl. No.: 19/387,867

(22) Filed: Nov. 13, 2025

(30) Foreign Application Priority Data
Nov. 22, 2024 (CN) 2024116793149

(51) Int. Cl. H01P 1/18; H01P 7/06; H01Q 1/24

(52) U.S. Cl. CPC H01P 1/18; H01P 7/06; H01Q 1/246

(57) ABSTRACT

A phase shifter assembly comprises a mounting surface and a cavity pair comprising side by side first and second cavities that are separated by a common separation wall, the first and second cavities having respective first and second hollow channels protruding forwardly from the mounting surface. First and second transmission lines are arranged in the respective first and second cavities. A feeder panel for feeding a radiating element is mounted on the mounting surface and has a feed section extending across the first and second hollow channels, where the coupling between a ground in the feed section and the cavity pair is changed such that the resonance caused by the coupling is at least partially shifted out from a predetermined operating frequency range.

### CROSS-REFERENCE TO RELATED APPLICATION

The present application claims priority to Chinese Patent Application No. 202411679314.9, filed Nov. 22, 2024, the entire content of which is incorporated herein by reference as if set forth fully herein.

### FIELD

The present application generally relates to radio communications, and more particularly relates to a phase shifter assembly, a feeder panel, a cavity phase shifter, and a base station antenna.

### BACKGROUND

Cellular base stations are well known in the art, and generally include baseband units, radio units, antennas and other components. Antennas are configured to provide bidirectional radio frequency (“RF”) communication with fixed and mobile subscribers (“users”) located throughout the cell. Generally, antennas are installed on towers or raised structures such as poles, roofs, water towers, etc., and separate baseband units and radio units are connected to the antennas.

FIG. 1 is a structural schematic diagram of a conventional cellular base station 40. The cellular base station 40 generally comprises a base station antenna 100 that is capable of being mounted on an antenna tower 44. The cellular base station 40 further comprises a baseband unit 41 and a radio unit 42. In order to simplify the attached drawing, a single baseband unit 41 and a single radio unit 42 are shown in FIG. 1. However, it should be understood that more than one baseband unit 41 and/or radio unit 42 may be provided. In addition, although the radio unit 42 is shown as being located at the same position as the baseband unit 41 at the bottom of the antenna tower 44, it should be understood that in other cases, the radio unit 42 may be a remote radio head (RRH) mounted on the antenna tower 44 adjacent to the base station antenna 100. The baseband unit 41 is capable of receiving data from another source (e.g., a backhaul network [not shown]), and is capable of processing the data and providing a data stream to the radio unit 42. The radio unit 42 may generate RF signals including data encoded therein and may amplify and transmit these RF signals to the base station antenna 100 through an RF cable 43 (e.g. a coaxial transmission cable). It should also be understood that the cellular base station 40 of FIG. 1 may generally also comprise various other devices (not shown), such as a power supply, a backup battery, a power bus, an antenna interface signal group (AISG) controller, and the like. Generally, a base station antenna 100 includes one or a plurality of phased arrays of radiation elements, wherein the radiation elements are arranged in one or a plurality of columns when the antenna is installed for use.

In order to transmit and receive RF signals to and from the defined coverage area, the antenna beams generated by a radiating element array included in the base station antenna 100 are generally inclined at a certain downward angle with respect to the horizontal plane (referred to as a “downtilt”). In some cases, the downtilt of the antenna beam is generated electrically by adjusting the relative phase of sub-components of RF signals fed to each set of radiating elements in the array that generates the antenna beam. The amount of electric downtilt applied to antenna beams generated by the radiating element array of the base station antenna 100 is capable of, in some cases, being adjusted from a remote location. When the base station antenna 100 has such an electrical tilting capability, the physical orientation of the base station antenna 100 may remain fixed, but the effective inclination angle of a generated antenna beam (e.g., the peak of the antenna beam relative to the directional angle of the horizontal plane) may still be electrically adjustable, such as by controlling a phase shifter that adjusts the relative phase of sub-components of RF signals provided to each radiating element in the array included in the base station antenna 100. The phase shifter and other related circuits are usually built in the base station antenna 100 and can be controlled from a remote location. Typically, an AISG control signal is used to control the phase shifter.

Each phase shifter and power divider is generally constructed together as part of a phase shift and feed network of the base station antenna 100 that feeds RF signals received from the radio unit 42 to the radiating element array comprised in the base station antenna 100. The power divider divides the RF signals into a plurality of sub-components, and the phase shifter applies an adjustable phase shift to each sub-component individually so that each sub-component is fed to the corresponding sub-array comprising one or a plurality of radiating elements. Many different types of phase shifters are known in the art, including rotary wiper arm phase shifters, trombone style phase shifters, sliding dielectric phase shifters, and sliding metal phase shifters. Each of the above types of phase shifters may be implemented as a cavity phase shifter, wherein the phase shifter may be enclosed in a metal housing coupled to an electrical ground.

However, in some application scenarios, the radio frequency performance of the cavity phase shifter may be poorer due to some undesirable resonance. This is undesirable.

### SUMMARY

According to the first aspect of the present application, it provided a phase shifter assembly, wherein the phase shifter assembly comprises: A mounting surface for mounting a feeder panel; a biasing cavity pair comprising a first cavity and a second cavity arranged side by side with each other and separated by a common separation wall, the first cavity has a first hollow channel protruding forwardly from the mounting surface, and the second cavity has a second hollow channel protruding forwardly from the mounting surface. A first transmission line is arranged in the first cavity, and a second transmission line is arranged in the second cavity; a feeder panel for feeding a radiating element has a feed section extending across a first hollow channel and a second hollow channel, wherein the coupling between a ground in the feed section and a offset cavity pair is changed such that the resonance caused by the coupling is at least partially shifted out from a predetermined operating frequency range.

According to the second aspect of the present application, it provided a feeder panel for feeding a radiation element comprising: a mounting section configured for mounting onto a mounting surface of a phase shifter assembly, and an electrical feed section configured for extending a first and a second hollow channel across a offset cavity pair of the phase shifter assembly and establishing a feed connection with a transmission line of the offset cavity pair, wherein a ground surface of the feed section includes a grounded metal area and further comprises: at least one metal removal feature, within which a metal overlay is removed; and/or at least one metal extension feature extending from a ground metal area, within which a metal overlay in addition to the ground metal area is present.

According to a third aspect of the present application, a cavity phase shifter is provided comprising: a mounting surface for mounting a feeder panel, the biasing cavity pair including first and second cavities arranged side by side with each other and separated by a common separation wall, wherein a first transmission line is mounted within the first cavity, and a second transmission line is mounted within the second cavity, wherein at least a first hollow channel protruding from the mounting surface and a second hollow channel protruding from the mounting surface, wherein, a transition surface is formed between the first hollow channel and the second hollow channel, and the ground of the feed section is oriented towards the transition surface, wherein not only the first hollow channel section and the second hollow channel section but also at least part of the transition surface section between them is removed in the area passed by the feed section.

According to the fourth aspect of the present application, a base station antenna is provided, including: A phase shifter assembly according to some examples of this application; and an array of radiating elements mounted on a mounting surface of the phase shifter assembly.

### BRIEF DESCRIPTION OF THE DRAWING

FIG. 1 is a structural schematic diagram of a conventional cellular base station.

FIG. 2 is a schematic view of a base station antenna.

FIGS. 3-5 show some schematic views of a cavity phase shifter assembly having a conventional cavity pair, which may include a mounting surface, a conventional cavity pair, and a feeder panel.

FIG. 6 shows a schematic view of a cavity phase shifter having one offset cavity pair.

FIG. 7 shows a schematic view of a cavity phase shifter having two offset cavity pairs.

FIGS. 8-12 show some schematic views of a cavity phase shifter assembly having a offset cavity pair, which may include a mounting surface, a offset cavity pair, and a feeder panel.

FIGS. 13-16 show some schematic views of a phased processor assembly according to a first exemplary embodiment of the present application.

FIG. 17 shows a partial schematic view of a phase shifter assembly according to a second exemplary embodiment of the present application.

FIG. 18 shows a partial schematic view of a phase shifter assembly according to a third exemplary embodiment of the present application.

FIG. 19 shows a stereoscopic view of a phase shifter assembly having two offset cavity pairs, which may be used for multi-frequency band antennas.

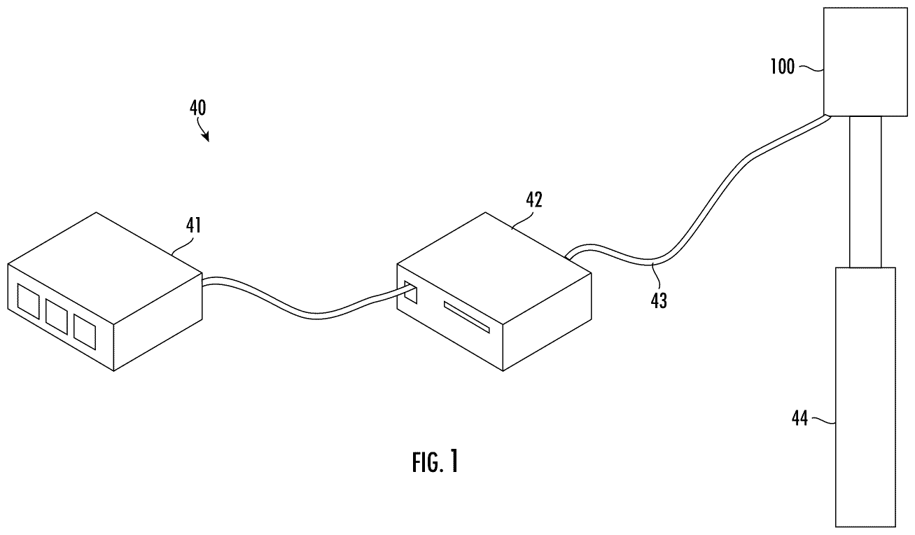

### DETAILED DESCRIPTION

The present application will be described below with reference to the attached drawings, wherein the attached drawings illustrate certain examples of the present application. However, it should be understood that the present application may be presented in many different ways and is not limited to the examples described below; in fact, the examples described below are intended to make the disclosure of the present application more complete and to fully explain the protection scope of the present application to those skilled in the art. It should also be understood that the examples disclosed in the present disclosure may be combined in various ways so as to provide more additional examples.

In various examples of different descriptions, same reference numerals or same element names are configured for same elements, wherein the disclosures contained in the full text of the Specification can be transferred to elements having same reference numerals or same element names as intended. Further, in various examples, the number of elements, implementations, and/or arrangement structures are not limited to the illustrated examples, but are capable of selecting other quantities, implementations, and/or arrangement structures according to actual needs.

As used herein, spatial relational terms such as “above,” “below,” “left,” “right,” “front,” “back,” “high,” “low,” and the like are used to describe the relationship of one feature to another feature in the attached drawings. It should be understood that spatial relational terms, in addition to the orientations shown in the attached drawings, also encompass different orientations of the apparatus during use or operation. For example, when the apparatus is flipped in the attached drawings, a feature previously described as “below” another feature may now be described as “above” that other feature. The apparatus may also be oriented in other ways (rotated 90 degrees or in other orientations), and the relative spatial relationships will be interpreted accordingly in those cases.

As used herein, the term “A or B” comprises “A and B” and “A or B”, not exclusively “A” or “B”, unless otherwise specified.

As used herein, the terms “illustrative” or “exemplary” mean “serving as an example, instance, or illustration,” rather than as a “model” to be precisely replicated. Any realization method described exemplarily herein is not necessarily interpreted as being preferable or advantageous over other realization methods. Furthermore, the present application is not limited by any expressed or implied theory given in the above technical field, background art, summary of the invention or embodiments.

As used herein, the term “substantially” means encompassing slight variations resulting from design or manufacturing defects, tolerances of components or elements, environmental influences, and/or other factors.

As used herein, the term “part” may be a part of any proportion. For example, it may be larger than 10%, 20%, 30%, 40%, 50%, 60%, 70%, 80%, 90%.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

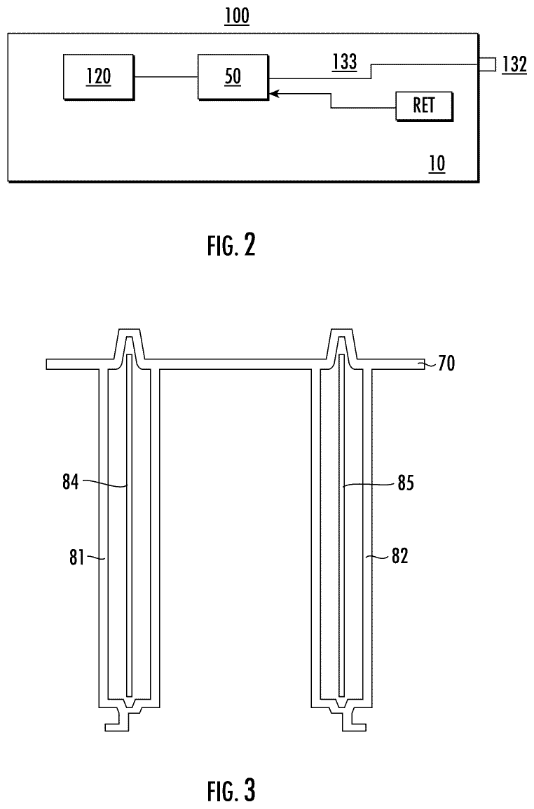

FIG. 2 shows a schematic view of a base station antenna 100. The base station antenna 100 usually comprises a radome (not shown) that provides environmental protection. As shown in FIG. 2, the base station antenna 100 may include a radio frequency port 132, cable 133, a remote electronic tilt (RET) unit, a phase shift and feed network 50 (which may also be referred to in this application as a phase shifter assembly 50 integrated with a feeder panel), and a radiation element array 120, among others. The radio frequency port 132 may be configured to receive an RF signal from a respective port of the radio unit. Each received RF signal may be coupled to the array of radiation element array 120 via a respective phase shift and feed network 50.

The phase shifter in the phase shift and feed network 50 may generally include a phase shift circuit and a power dispenser circuit that allows for the application of a phase taper to the sub-component of the RF signal fed to the radiative element in the array 120. By adjusting the amount of the phase tapers applied, the resulting antenna beams may be charged on a pitch plane to downward dip to a desired angle. Such technique may be used for adjusting how far the antenna beams extend outwardly from the antenna and may therefore be used for adjusting a coverage area of the base station antenna 100.

The base station antenna 100 may comprise a reflective plate 10. The reflective plate 10 may comprise a metal surface that provides a grounded plane and reflects electromagnetic radiation reaching the metal surface, such that the electromagnetic radiation is redirected to propagate, for example, forwardly. When using a cavity phase shifter, in some examples, the reflective plate 10 of the base station antenna 100 may be at least partially combined by a front surface or, alternatively, a mounting face 70 of a plurality of the cavity phase shifters. In some examples, the base station antenna 100 may include a separate reflective plate 10 and the cavity phase shifter may be mounted to a rear side of the reflective plate 10 via a front surface thereof or mounting surface 70.

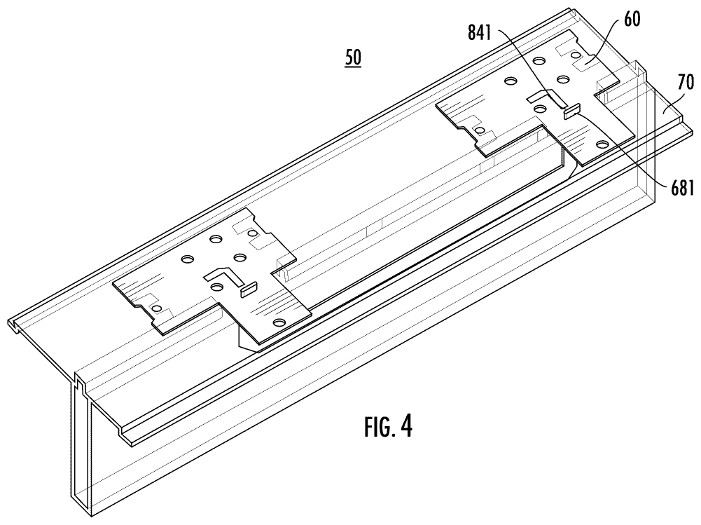

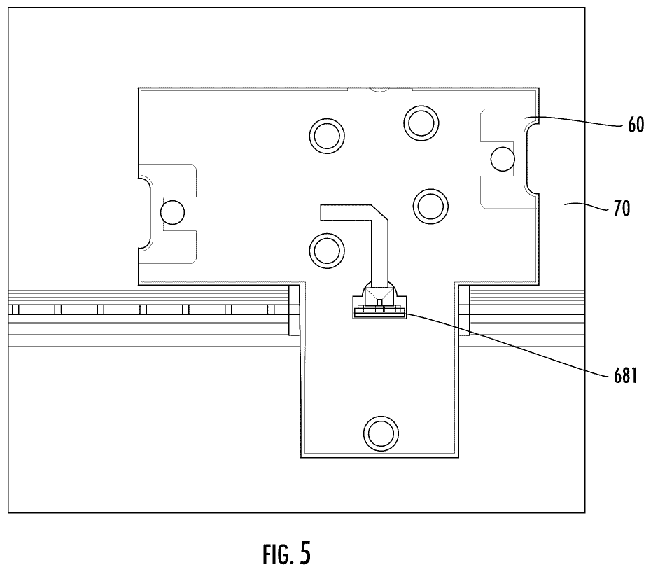

FIGS. 3-5 illustrate schematically some views of the cavity phase shifter assembly 50. The cavity phase shifter assembly 50 may include a mounting surface 70 for mounting the feeder panel 60, conventional cavity pairs 81, 82, and a feeder panel 60 for feeding the radiation element.

In some examples, a first transmission line 84 for a first polarized RF signal may be mounted within the first cavity 81, for example, and a second transmission line 85 for a second polarized RF signal may be mounted within the second cavity 82, for example. Bipolarized feeds for the radiating element are thereby achieved. In some examples, e.g., a first transmission line 84 for a first polarized RF signal for a first operating frequency band may be mounted within the first cavity 81, and a second transmission line 85 for a second operating frequency band may be mounted within the second cavity 82. This thereby enables a multi-frequency feed for the radiating element.

The connecting port 841 of the first transmission line 84 may extend through the first slot 681 on the feeder panel 60 so as to electrically connect with the feeder panel 60, such as by welding, thereby feeding the radiating element via the feeder panel 60. Similarly, the connecting end of the second transmission line 85 may extend through a second slot on the feeder panel 60 in order to electrically connect with the feeder panel 60, such as by welding, thereby feeding the radiating element via the feeder panel 60.

In some examples, the first transmission line 84 and second transmission line 85 may generally be printed on a printed circuit board as traces, respectively. In other examples, the first transmission line 84 and/or second transmission line 85 may be implemented as conductive metal lines. It should be understood that the respective transmission lines may include, for example, a phase shift line and a power distribution line.

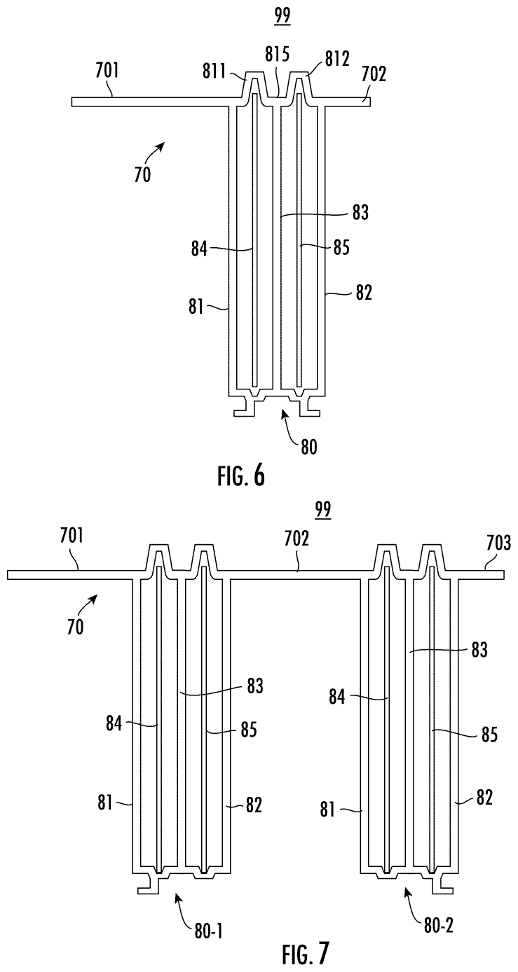

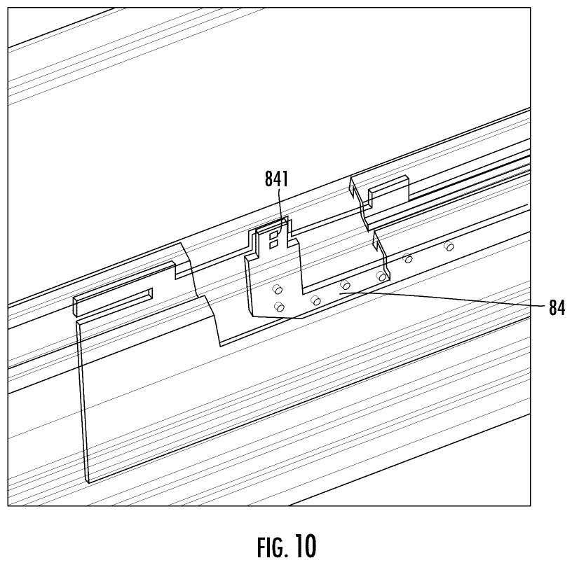

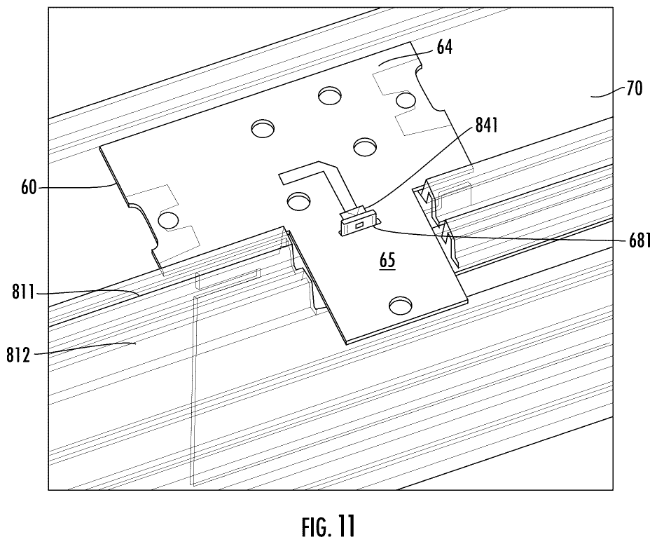

Referring to FIGS. 6-12, a phase shifter assembly 50 having an offset cavity pair 80 is shown in further detail. It should be understood that the labeled axes in the diagram indicate the vertical or longitudinal direction (V axis), horizontal or transverse direction (H axis), and forward direction (F axis) of the base station antenna 100.

FIGS. 6 and 7 show a cavity movement 99 having an offset cavity pair 80. The first cavity 81 and second cavity 82 of each offset cavity pair 80 may be arranged side-by-side with each other (with mounting into the base station antenna 100, arranged side-by-side with each other in the horizontal direction H) and separated from each other by a common separation wall 83, distinct from the conventional cavity pair of FIG. 3. Accordingly, such offset cavity pair 80 may advantageously have a compact structure.

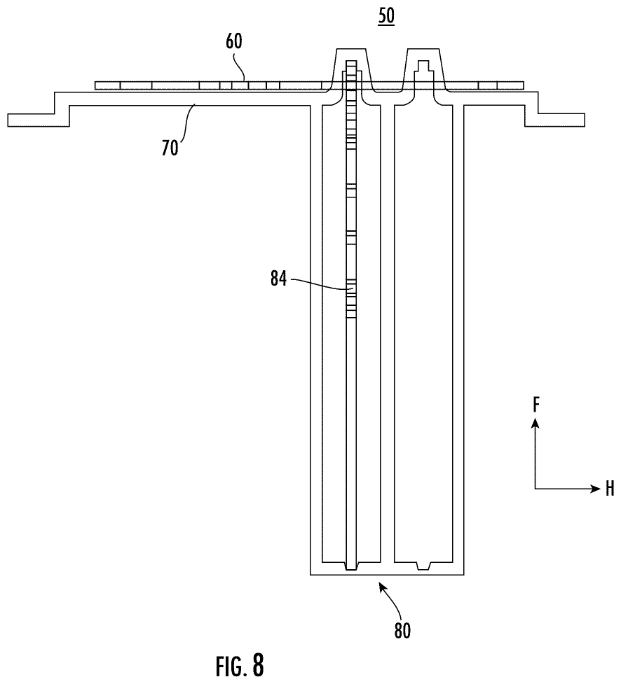

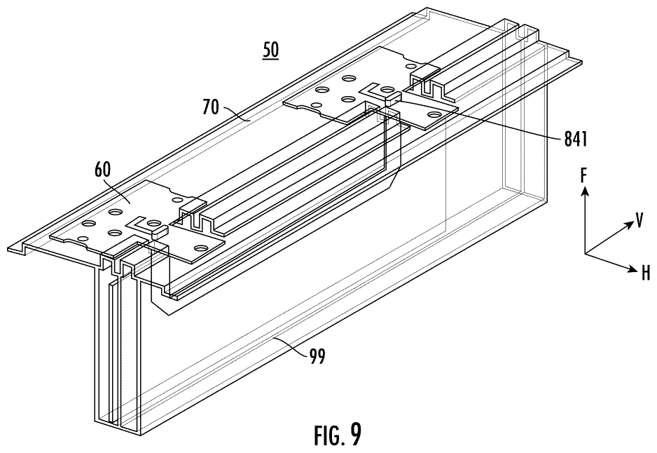

In the example shown in FIG. 6, the cavity phase shifter 99 may have an offset cavity pair 80. In connection with FIGS. 8-12, a first transmission line 84 may be installed within the first cavity 81, for example, for a first polarized RF signal, and the connecting port 841 of the first transmission line 84 may extend through the first slot 681 on the feeder panel 60 in order to electrically connect with feeder panel 60, such as by welding, thereby feeding the radiation element to the first polarized RF signal via the feeder panel 60. Similarly, a second transmission line 85 may be installed within the second cavity 82, for example, for a second polarized RF signal, and the connecting port of the second transmission line 85 may extend through the second slot on the feeder panel 60 in order to electrically connect with the feeder panel 60, such as by welding, thereby feeding the second polarized RF signal to the radiating element via the feeder panel 60.

In the example shown in FIG. 7, the cavity phase shifter 99 may have two offset cavity pairs 80. In conjunction with FIGS. 8-12, the first offset cavity pair 80-1 may be configured for feeding a first polarized RF signal to the radiating element via the feeder panel 60 in a first operating frequency band and a second operating frequency band. The first transmission line 84 for first polarized RF signal for a first operating frequency band may be mounted within the first cavity 81 of the first offset cavity pair 80-1, and a second transmission line 85 for a first polarized RF signal for a second operating frequency band may be mounted within the second cavity 82 of the first offset cavity pair 80-1. Similarly, the second offset cavity pair 80-2 may be configured for feeding a second polarized RF signal of the first and second operating frequency bands to the radiating element via the feeder panel 60. Within the first cavity 81 of the second offset cavity pair 80-2, a first transmission line 84 may be mounted for a second polarized RF signal of the first operating frequency band, and within the second cavity 82 of the second offset cavity pair 80-2, a second transmission line 85 may be mounted for a second polarized RF signal for the second operating frequency band, for example. This allows for multi-band operation of the antenna.

The first cavity 81 of the offset cavity pair 80 may have a first hollow channel 811 protruding forward from the mounting face 70, and the second cavity 82 of the offset cavity pair 80 may have a second hollow channel 812 protruding forward from the mounting face 70. As such, the front surface of the phase shifter assembly 50 may in turn comprise: A first mounting face section 701, a first hollow channel 811, a channel transition face 815, a second hollow channel 812, and a second mounting face section 702 abutting the second cavity 82 abutting the first cavity 81. With the two offset cavity pairs 80-1, 80-2, as shown in FIG. 7, the mounting surface 70 of the phase shifter assembly 50 may comprise: A first mounting surface section 701 abutting a first cavity 81 of a first offset cavity pair 80-1; a third mounting surface section 703 abutting a second cavity 82 of a second offset cavity pair 80-2; and a second mounting surface section 702 between a second cavity 82 of a first offset cavity pair 80-1 and a first cavity 81 of a second offset cavity pair 80-2.

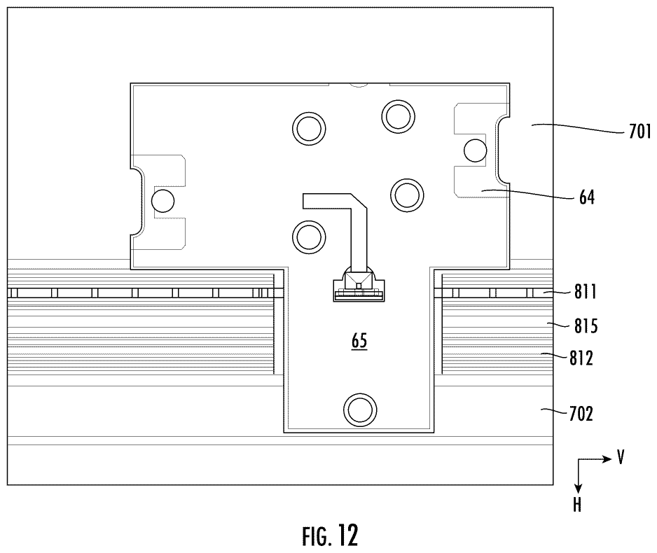

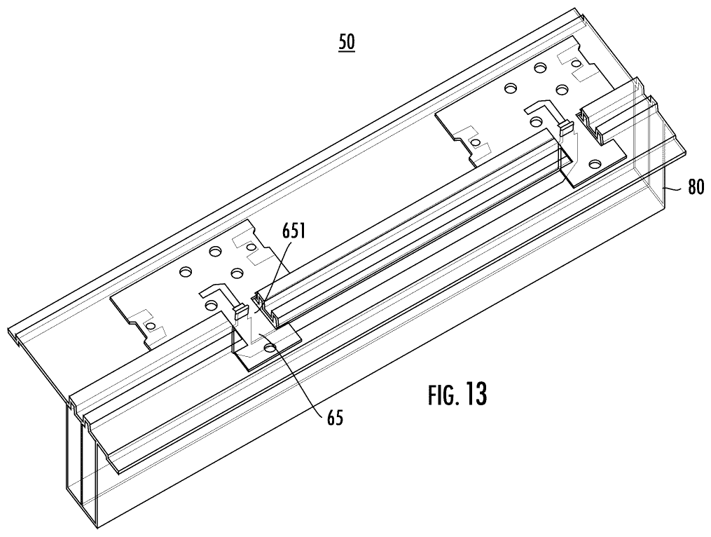

As shown in FIGS. 11 and 12, the feeder panel 60 may include a feed section 65 configured to extend a first hollow channel 811 and a second hollow channel 812 across one (each) of the offset cavity pairs 80 of the phase shifter assembly 50 and establish a feed electrical connection with a transmission line within the offset cavity pair 80. The feeder panel 60 may also include one or more mounting sections 64, which may be configured for mounting to a mounting surface 70 of the phase shifter assembly 50. For example, the feeder panel 60 may be secured to each mounting surface section of the phase shifter assembly 50 by means of riveting and/or bonding, respectively.

While this phase shifter assembly 50 with an offset cavity pair 80 has a favorable compact structure, such a compact structure may result in undesirable resonance that may fall into the operating frequency band of the antenna and negatively affect the radio frequency performance of the antenna. After research, the inventors have found that: In the case of an offset cavity pair 80, the coupling scene between the feeding section 65 of the feeder panel 60 and the offset cavity pair 80 varies as distinct from a conventional cavity pair. For example, the feed section 65 needs to extend through the two tight hollow channels 811, 812 and the narrow transition surface 815 therebetween, whereby the coupling between the ground surface of the feed section 65 towards the offset cavity pair 80 (to the back side so it is not visible) and the offset cavity pair 80 varies. Such coupling variations may generate resonance that falls within the operating frequency band of the antenna, thereby negatively affecting the radio frequency performance of the antenna. To this end, the present disclosure recommends that the resonance caused by the coupling between the ground surface of the feed section 65 and the offset cavity pair 80 be changed such that the resonance caused by the coupling is at least partially shifted out from the predetermined operating frequency range.

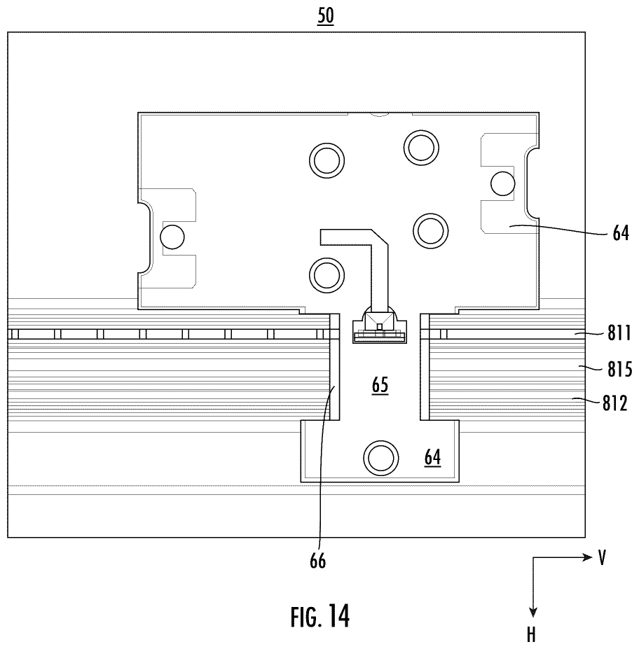

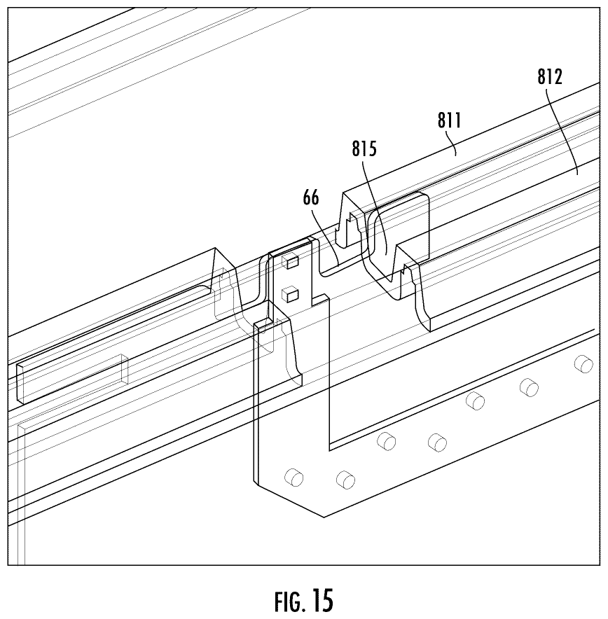

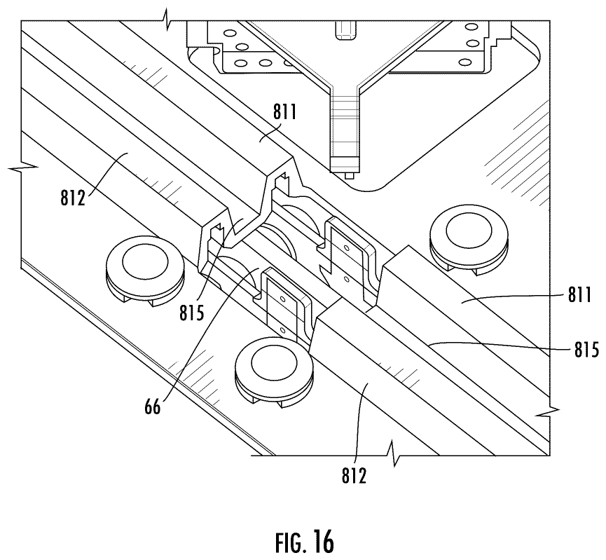

Referring to FIGS. 13-16, the phase shifter assembly 50 according to a first embodiment of the present application is described in detail. In a first embodiment of the phase shifter assembly 50, it is proposed to change the coupling between the ground surface 651 of the feed section 65 (ground surface 651 of the perspective backside) and the offset cavity pair 80:
Within the area that the feed section 65 passes, not only the first and second hollow channel sections, but also at least a portion or all of the transitional face sections therebetween are removed. As shown in FIGS. 15 and 16, by removing at least a portion or all of the first hollow channel section, the second hollow channel section, and the transitional face section therebetween, the offset cavity pair 80 may form a continuous window 66 within the area that the feed section 65 passes over. This continuous window 66 may expose the interior space of the offset cavity pair 80, such as the first transmission line 84, the second transmission line 85, and the common separation wall 83 inside. Advantageously, the continuous window 66 may provide a consistent channel for the feed section 65 to pass. When viewed from the front, the continuous window 66 may have a regular projected profile, such as a substantially rectangular projected profile, and the width of the continuous window 66 may be slightly larger than the width of the feed section 65. In some examples, the range of transitional sections to be removed may be flexibly adjusted in light of the actual situation so as to remove the generated resonance as much as possible from the operating frequency band.

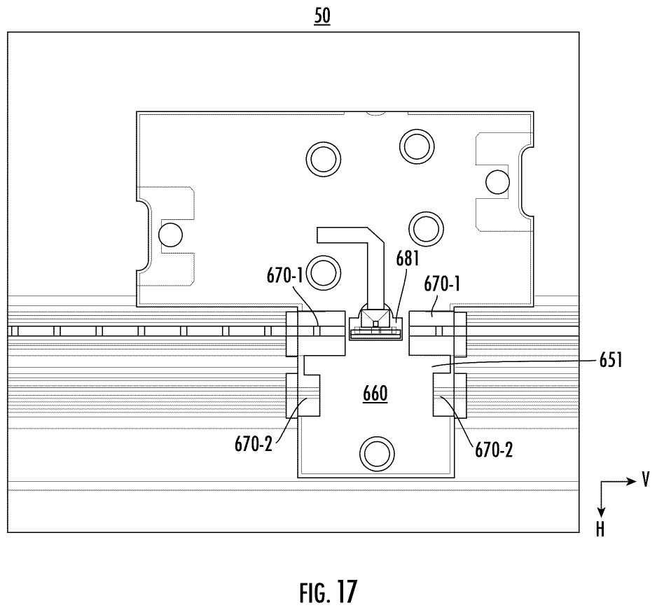

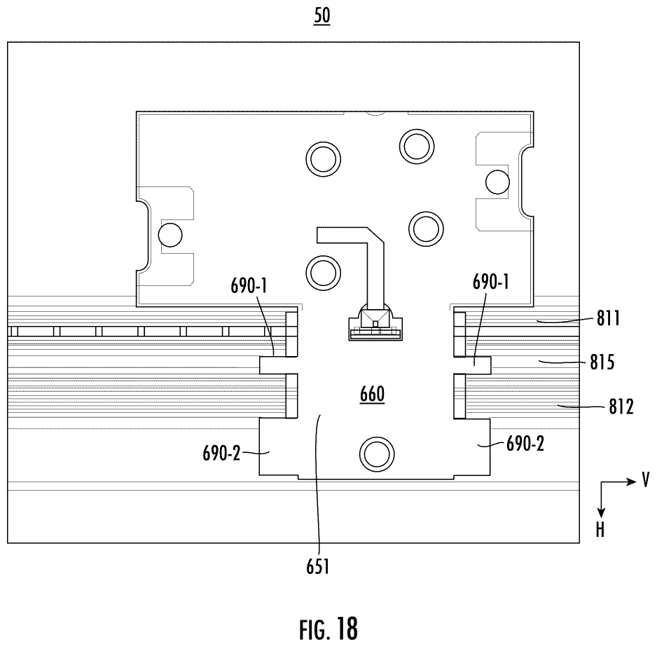

Referring to FIG. 17, the phase shifter assembly 50 according to a second embodiment of the present application is described in detail. In a second embodiment of the phase shifter assembly 50, it is proposed to change the coupling between the ground surface 651 (shown in back in the view) of the feed section 65 and the offset cavity pair 80: At least one metal removal feature 670 is provided for the ground surface 651 of the feed section 65. The metal removal feature 670 may be understood as an area within which there is no metal overlay or where the metal overlay is removed. The coupling between the ground surface 651 of the feed section 65 and the offset cavity pair 80 may be effectively changed by the placement of a dedicated metal removal feature 670 on the ground surface 651 of the feed section 65.

As shown in FIG. 17, the grounding surface 651 of the feed section 65 may include a ground metal area 660 and at least one metal removal feature 670. Advantageously, the ground surface 651 of the feed section 65 may include a plurality of metal removal features 670 that are substantially symmetrically disposed with one another.

In some embodiments, the ground surface 651 of the feed section 65 may include a first metal removal feature 670-1 which may be in an area corresponding to the first hollow channel section being removed. Advantageously, the ground surface 651 of the feed section 65 may include two opposing first metal removal features 670-1 which may be separated via the ground metal area 660. A first slot 681 may be provided between the two first metal removal features 670-1, for example, with a connecting end for the first transmission line 84 to extend through.

Additionally, or alternatively, the ground surface 651 of the feed section 65 may include a second metal removal feature 670-2, which may be in an area corresponding to the second hollow channel section being removed. Advantageously, the ground surface 651 of the feed section 65 may include opposing two second metal removal features 670-2, which may be separated via the ground metal area 660. In some examples, as shown in FIG. 17, the offset cavity pair 80 may be electrically connected with the feeder panel 60 only through a connecting end of the first transmission line. In other embodiments, a second slot may be provided between the two second metal removal features 670-2, for example, for a connecting end of the second transmission line 85 to extend through.

It should be understood that the size parameters of the first and second metal removal features 670-1, 670-2 may be the same or different from one another. The extension dimension of the respective metal removal feature 670 may be, for example, between 1 millimeters and 5 millimeters. In some examples, as shown in FIG. 17, the extension dimension of the first metal removal feature 670-1 may be longer than the extension dimension of the second metal removal feature 670-2. In some examples, the shape of the respective metal removal feature 670 may have a substantially regular shape, such as a shape of a rectangle. Further, the grounded metal area 660, together with the various metal removal features 670, may form a substantially rectangular shape. It should be understood that the shape of the metal removal feature 670 may be flexibly adjusted to the actual situation in order to maximize the movement of the generated resonance from the operating frequency band.

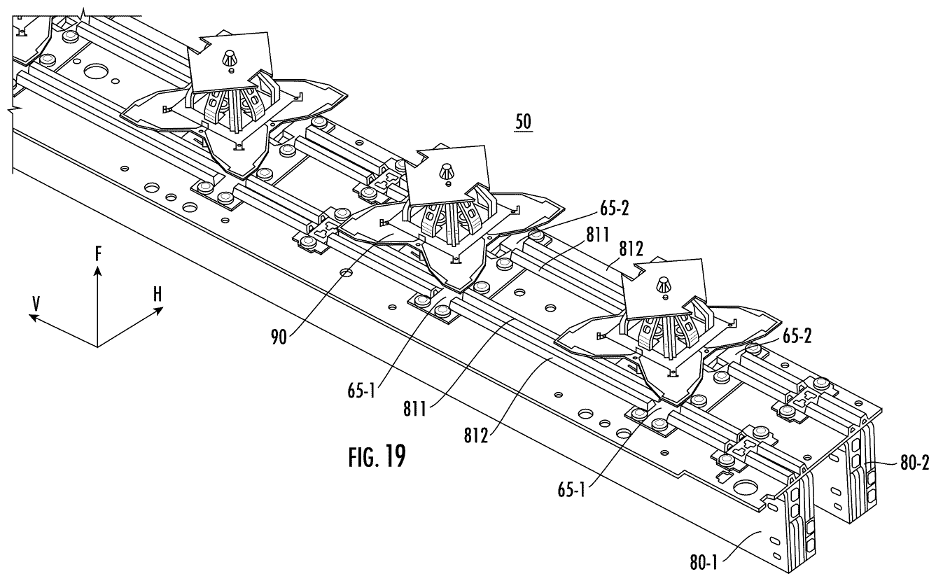

Referring to FIG. 18, the phase shifter assembly 50 according to a third embodiment of the present application is described in detail. In a third embodiment of the phase shifter assembly 50, it is proposed to change the coupling between the ground surface 651 of the feed section 65 and the offset cavity pair 80: At least one metal extension feature 690 is provided for the ground surface 651 (shown in back side in the view) of the feed section 65. The metal extension feature 690 may be understood as an additional metal area beyond the original ground metal area 660. The metal extension feature 690 may extend along the longitudinal V of the offset cavity pair 80, for example, from the ground metal area 660. The coupling between the ground surface 651 of the feed section 65 and the offset cavity pair 80 may be effectively changed by the placement of a dedicated metal extension feature 690 on the ground surface 651 of the feed section 65.

As shown in FIG. 18, the ground surface 651 of the feed section 65 may include a ground metal area 660 and at least one metal extension feature 690 extending from the ground metal area 660 within the metal extension feature 690 having a metal overlay in addition to the ground metal area 660 such that the coupling between the ground surface 651 of the feed section 65 and the offset cavity pair 80 is changed.

Advantageously, the grounding surface 651 of the feed section 65 may include a plurality of metal extension features 690 disposed substantially symmetrical to one another.

In some embodiments, the ground surface 651 of the feed section 65 may include a first metal extension feature 690-1 extending from the ground metal area 660 onto a transition surface 815 between the first and second hollow channels 811 and 812. Advantageously, the ground surface 651 of the feed section 65 may include two opposing first metal extension features 690-1 that are respectively connected to opposing sides of the ground metal area 660.

Additionally, or alternatively, the grounding surface 651 of the feed section 65 may include a second metal extension feature 690-2 extending from the ground metal area 660 into a second mounting surface 702 of the mounting surface 70 contiguous with the second cavity 82. Advantageously, the ground surface 651 of the feed section 65 may include two opposed second metal extension features 690-2 that are respectively connected to opposing sides of the ground metal area 660.

It will be understood that the size parameters of the first and second metal extension features 690-1, 690-2 may be the same or different from one another. The extension dimension of the respective metal extension feature 690 may be, for example, between 2 millimeters and 10 millimeters. In some examples, the ground metal area 660 has a substantially rectangular shape, and the shape of the respective metal extension feature 690 may protrude into an elongated metal strip or rectangular strip of the ground metal area 660. It should be understood that the shape of the metal removal feature 690 may be flexibly adjusted to the actual situation in order to maximize the movement of the generated resonance from the operating frequency band.

Additionally, or alternatively, in a fourth embodiment of the phase shifter assembly 50 (not shown), to change the coupling between the ground surface of the feed section 65 and the offset cavity pair 80, it is proposed that an electro-media layer is provided between the ground surface of the feed section 65 and the offset cavity pair 80, by virtue of which the coupling between the ground surface of the feeding section 65 and the offset cavity pair 80 is changed such that the resonance caused by the coupling is at least partially shifted out from the predetermined operating frequency range.

With reference to FIG. 19, a phase shifter assembly 50 having two offset cavity pairs 80, which may be utilized for a multi-frequency band antenna, is shown. As shown in FIG. 19, the feeder panel 60 may include: The first feed section 65-1 extending across the first hollow channel 811 and second hollow channel 812 of the first offset cavity pairs 80-1; and first feed section 65-2 extending across the first hollow channel 811 and second hollow channel 812 of the second offset cavity pairs 80-2, wherein the coupling between the grounding surface of the first feed section 65-1 and the first offset cavity 80-1 is changed, making the resonance caused by said coupling at least partially moved from a predetermined operating frequency, and/or the coupling between the grounding surface of the second feed section 65-2 and the second offset cavity 80-2 is changed, making the resonance caused by said coupling at least partially moved from a predetermined operating frequency.

The first offset cavity pair 80-1 may be configured to feed a first polarized RF signal to the radiation element 90 via the feeder panel 60 in a first operating frequency band and a second operating frequency band. The second offset cavity pair 80-2 may be configured for feeding a second polarized RF signal to the radiation element 90 via the feeder panel 60 in the first operating frequency band and a second operating frequency band. This allows for multi-band operation of the antenna.

It should be understood that the various embodiments and examples presented in this application may be implemented separately from each other or in combination with each other, and should not be limited to the presently presented examples themselves.

Although some specific embodiments and examples of the present application have been described in detail through examples, those skilled in the art should understand that the above examples are only for illustration rather than for limiting the scope of the present application. Various examples disclosed herein can be combined arbitrarily without departing from the spirit and scope of the present disclosure. Those skilled in the art should also understand that various modifications may be made to the examples without departing from the scope and spirit of the present disclosure. The scope of the present application is defined by the attached claims.

1. A phase shifter assembly comprising:
a mounting surface for mounting the feeder panel;
an offset cavity pair comprising a first cavity and a second cavity arranged side by side with each other and separated by a common separation wall, the first cavity having a first hollow channel protruding forward from the mounting surface, and the second cavity having a second hollow channel protruding forward from the mounting surface, wherein a first transmission line is mounted within the first cavity and a second transmission line is mounted within the second cavity; and
a feeder panel for feeding a radiation element, wherein the feeder panel has a feed section extending across the first and second hollow channels, wherein the coupling between a ground surface of the feed section and the offset cavity pair is changed such that the resonance caused by the coupling is at least partially shifted out from a predetermined operating frequency range.

2. The phase shifter assembly according to claim 1, wherein a transition surface is formed between the first and second hollow channels, the ground surface of the feed section being directed towards the transition surface, wherein not only at least a portion of the first and second hollow channel sections, but also transitional surface sections therebetween, is removed such that the coupling between the ground surface of the feed section and the offset cavity pair is changed.

3. The phase shifter assembly according to claim 2, wherein a continuous window is formed within the area that the feeding section passes through by removing the first hollow channel section, the second hollow channel section, and transitional surface sections therebetween, the window exposing the offset cavity to a first transmission line, a second transmission line, and a common separation wall inside.

4. The phase shifter assembly according to claim 1, wherein the mounting surface comprises a first mounting face section contiguous with the first cavity and a second mounting face section contiguous with the second cavity, the feeder panel being affixed to each mounting face section by means of riveting and/or bonding, respectively.

5. The phase shifter assembly according to claim 1, wherein the ground surface of the electrical feed section includes a ground metal area and at least one metal removal feature, a metal overlay within the metal removal feature being removed such that the coupling between the ground surface of the feed section and the offset cavity pair is changed.

6. The phase shifter assembly according to claim 5, wherein the ground metal area forms a substantially rectangular shape with the various metal removal features.

7. The phase shifter assembly according to claim 5, wherein within an area of the feed section, a first hollow channel section and a second hollow channel section are removed,
wherein the ground surface of the feed section comprises:
a first metal removal feature in an area corresponding to the first hollow channel section being removed; and/or
a second metal removal feature in an area corresponding to the second hollow channel section being removed.

8. The phase shifter assembly according to claim 7, wherein the ground surface of feed section further comprises:
two opposing first metal removal features separated via a ground metal area; and/or
two opposing second metal removal features separated via a ground metal area.

9. The phase shifter assembly according to claim 8, wherein
providing a first slot between the two first metal removal features for a connecting end of a first transmission line to extend through; and/or
a second slot between the two second metal removal features for a connecting end of a second transmission lines to extend through.

10. The phase shifter assembly according to claim 1, wherein the ground surface of the feeding section includes a ground metal area and at least one metal extension feature extending from the ground metal area, within the metal extension feature having a metal overlay in addition to the ground metal area such that the coupling between the ground surface of the feeding section and the offset cavity pair is changed.

11. The phase shifter assembly of claim 10, wherein the metal extension feature extends from a ground metal area along a longitudinal direction of the offset cavity pair.

12. The phase shifter assembly of claim 10, wherein the ground metal area has a substantially rectangular shape and the metal extension feature forms an elongated metal strip.

13. The phase shifter assembly of claim 10, wherein within an area of the feed section, a first hollow channel section and a second hollow channel section are removed,
wherein the ground surface of the feed section comprises:
a first metal extension feature extending from a ground metal area onto a transition surface between the first and second hollow channels; and/or
a second metal extension feature extending from a grounded metal area into a second mounting surface section of the mounting surface that abuts the second cavity.

14. The phase shifter assembly according to claim 13, wherein the ground surface of feed section further comprises:
two opposing first metal extension features connected to opposing sides of the ground metal area respectively; and/or
two opposed second metal extension features connected to opposing sides of the ground metal area respectively.

15. The phase shifter assembly according to claim 1, wherein the phase shifter assembly includes two offset cavity pairs, wherein the feeder panel includes:
a first feed section extending across a first hollow channel and a second hollow channel of a first offset cavity pair; and
a second feed section extending across a first hollow channel and a second hollow channel of a second offset cavity pair,
wherein the coupling between the ground surface of the first feed section and the first offset cavity pair is changed such that the resonance caused by the coupling is at least partially moved from the predetermined operating frequency range, and/or the coupling between the ground surface of the second feed section and the second offset cavity pair is changed such that the resonance caused by the coupling is at least partially moved from the predetermined operating frequency range.

16. The phase shifter assembly according to claim 15, wherein the mounting surface further comprises:
a first mounting surface section contiguous with a first cavity of a first offset cavity pair;
a third mounting surface section contiguous with a second cavity of a second offset cavity pair; and
a second mounting surface section between a second cavity of a first offset cavity pair and a first cavity of a second offset cavity pair,
wherein the said feeder panel is affixed to the various mounting surface sections by means of riveting and/or bonding, respectively.

17. The phase shifter assembly according to claim 1, wherein an electro-media layer is provided between the ground surface of the feeding section and the offset cavity pair, by way of which the coupling between the ground surface of the feed section and the offset cavity pair is changed such that the resonance caused by the coupling is at least partially moved from the predetermined operating frequency range.

18. A feeder panel for feeding a radiation element, comprising:
a mounting section configured for mounting onto a mounting surface of a phase shifter assembly, and
an electrical feed section configured to extend cross a first hollow channel and a second hollow channel of an offset cavity pair of a phase shifter assembly and establish a feed connection with a transmission line of the offset cavity pair,
wherein the ground surface of the feed section comprises a ground metal area and further comprises:
at least one metal removal feature within which a metal overlay is removed; and/or
at least one metal extension feature extending out from a ground metal area within which a metal overlay in addition to the ground metal area is present.

19-25. (canceled)

26. A cavity phase shifter, comprising:
a mounting surface for mounting the feeder panel;
an offset cavity pair comprising a first cavity and a second cavity arranged side by side with each other and separated by a common separation wall, wherein a first transmission line is mounted within the first cavity and a second transmission line is mounted within the second cavity,
wherein the first cavity has a first hollow channel protruding forward from the mounting surface and the second cavity has a second hollow channel protruding forward from the mounting surface, wherein a transition surface is formed between the first and second hollow channels, the ground surface of the feed section being towards the transition surface, wherein within the area of the feed section, not only the first and second hollow channel sections are removed, but at least a portion of the transition surface therebetween.

27. The phase shifter assembly according to claim 26, wherein a continuous window is formed within the area that the feeding section passes through by removing the first hollow channel section, the second hollow channel section, and transitional surface sections therebetween, the window exposing the offset cavity to a first transmission line, a second transmission line, and a common separation wall inside.

28-30. (canceled)
